(19) United States
(12) Patent Application Publication
(10) Pub. No.: US 2004/0177343 A1
(43) Pub. Date: Sep. 9, 2004

(54) Method and apparatus for understanding and resolving conflicts in a merge

(76) Inventors: Lawrence W. McVoy, San Francisco, CA (US); Wayne H. Scott, Churubusco, IN (US); Bryan D. Oakley, Tulsa, OK (US)

Correspondence Address: Robert P. Lenart, Pietragallo, Bosick & Gordon, One Oxford Centre, 38th Floor, 301 Grant Street, Pittsburgh, PA, 15219, US

(21) Appl. No.: 10/700,017

(22) Filed: Nov. 3, 2003

Related U.S. Application Data
(60) Provisional application No. 60/423,475, filed on Nov. 4, 2002.

(51) Int. Cl. G06F 9/44

(52) U.S. Cl. 717/122; 717/110; 717/143

(57) ABSTRACT

A method is provided for merging first and second computer files wherein the first and second computer files are modified versions of a common computer file. The method comprises the steps of producing a first set of stacked diffs between the first computer file and the common computer file, producing a second set of stacked diffs between the second computer file and the common computer file, and simultaneously displaying the first and second sets of stacked diffs, wherein common lines of the first and second sets of stacked diffs are aligned and new lines of each of the first and second sets of stacked diffs are aligned with blank lines of the other stacked diff. Apparatus for performing the method and a computer readable medium including a computer program for performing the method are also included.

### CROSS-REFERENCE TO RELATED APPLICATION

This application claims the benefit of U.S. Provisional Patent Application Serial No. 60/423,475, filed Nov. 4, 2002, the disclosure of which is hereby incorporated by reference.

### FIELD OF THE INVENTION

The invention relates generally to methods and apparatus for modifying computer software, and more specifically, to methods and apparatus for understanding and/or resolving parallel changes to the same file (document, program, web page, etc.).

### BACKGROUND OF THE INVENTION

In a software development environment, developers may edit a file to add new content and/or to change/update and/or otherwise alter the file. With the relative ease that files can be copied and distributed, several different developers may do this simultaneously. Thus, if each person makes one or more changes, the others may not know what has been done. Without some form of coordination between the various programmers, there will be no single correct and updated version.

In some cases, developers may choose to use a version control system to help in coordinating the access and modification of files. Many version control systems are capable of tracking changes made in parallel to files, and computing where a common starting point is between any two versions made in parallel.

In other cases, developers who are not using a version control system may agree to set aside a copy that represents the original before any modifications are done. Each participant then may choose to modify a copy of the original. In either case, the conflict resolution problem arises when the versions are merged.

Each computer file contains some kind of data. The data may or may not be in textual form. An original file is referred to as a Greatest Common Ancestor (GCA). Two copies of a GCA can be made, a Local Copy and a Remote Copy. Both the Local Copy and the Remote Copy can be modified to produce a Locally Modified Version (LMV) and a Remotely Modified Version (RMV).

The changes leading from GCA to LMV can be combined with the changes leading from GCA to RMV to create a Merged Version, with the merged result containing all of the changes and a resolution of any conflicts between the LMV and the RMV. The process of merging the versions includes stepping through each area of conflict and choosing actions which lead to a resolution of conflict.

There is a need for a method and apparatus that displays changes between the GCA and the LMV and RMV in a manner that facilitates the selection of updated versions of a file and the resolution of conflicts therein.

### SUMMARY OF THE INVENTION

A method is provided for merging first and second computer files wherein the first and second computer files are modified versions of a common computer file. The method comprises the steps of producing a first set of stacked diffs between the first computer file and the common computer file, producing a second set of stacked diffs between the second computer file and the common computer file, and simultaneously displaying the first and second sets of stacked diffs, wherein common lines of the first and second sets of stacked diffs are aligned and new lines of each of the first and second sets of stacked diffs are aligned with blank lines inserted in the other stacked diff.

The first and second sets of stacked diffs can be scrolled together. Conflicts between the first and second computer files can be displayed with only one conflict being active at a time. Version control system metadata relating to the active conflict can also be displayed. The version control system may provide metadata pertaining to the version where the data was created, and/or to the version where data was deleted. Metadata may be comprised of a revision number, date, checkin comments, and/or user identification.

The step of displaying version control system metadata relating to the active conflict can include the steps of searching an active conflict of the stacked diffs, creating a list of revisions for lines deleted from the active portion, creating a list of revisions for lines added from the active portion, and displaying the version control metadata relating to the deleted lines and/or the added lines.

The method can further comprise the steps of selecting one line or block of lines from either of the first and second sets of stacked diffs, copying the selected lines to a conflict resolution pane, and repeating the selecting and copying steps to achieve a conflict resolution.

In another aspect, the invention encompasses an apparatus for merging first and second computer files wherein the first and second computer files are modified versions of a common computer file, the apparatus comprising: means for producing a first set of stacked diffs between the first computer file and the common computer file and for producing a second set of stacked diffs between the second computer file and the common computer file; and means for simultaneously displaying the first and second sets of stacked diffs, wherein common lines of the first and second sets of stacked diffs are aligned and new lines of each of the first and second sets of stacked diffs are aligned with blank lines inserted in the other stacked diff.

The invention also encompasses a computer readable medium including a computer program for merging first and second computer files wherein the first and second computer files are modified versions of a common computer file, the computer readable medium comprising: computer readable means for producing a first set of stacked diffs between the first computer file and the common computer file and for producing a second set of stacked diffs between the second computer file and the common computer file; and computer readable means for simultaneously displaying the first and second sets of stacked diffs, wherein common lines of the first and second sets of stacked diffs are aligned and new lines of each of the first and second sets of stacked diffs are aligned with blank lines inserted in the other stacked diff.

### BRIEF DESCRIPTION OF THE DRAWINGS

FIG. 1 is a block diagram showing an overview of the merge process.

FIG. 2 shows sample files that are used in the description of the present invention.

FIGS. 3a and 3b show sample files that illustrate a definition and generation of a “stacked diff”.

FIG. 4 is a schematic representation of a visual interface used in an embodiment of the invention.

FIG. 5 is a flow diagram of one aspect of the invention.

FIG. 6 is a schematic representation of a visual interface used in another embodiment of the invention.

FIG. 7 is a flow diagram of another aspect of the invention.

FIG. 8 is a schematic representation of a visual interface used in another embodiment of the invention.

FIGS. 9 and 10 are flow diagrams of other aspects of the invention.

FIG. 11 is a schematic representation of a visual interface used in another embodiment of the invention.

FIG. 12 is a representation of a computer system that can be used to practice the invention.

### DETAILED DESCRIPTION OF THE INVENTION

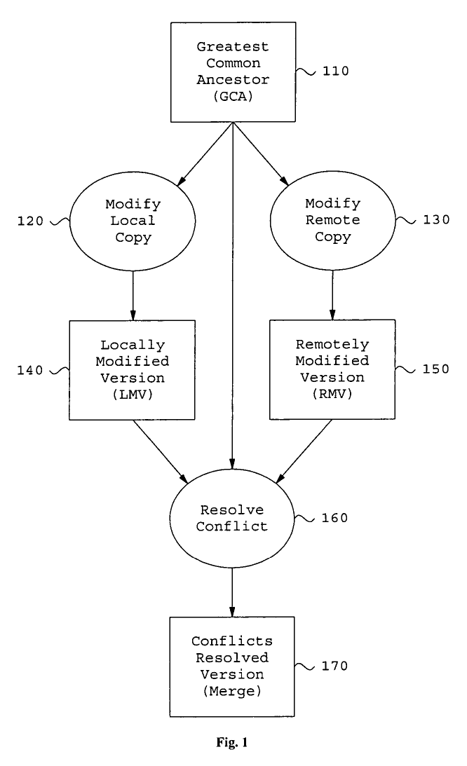

Referring to the drawings, FIG. 1 is a block diagram showing an overview of the merge process. A Greatest Common Ancestor (GCA) file 110 is used to produce a local file and a remote file. The local file is changed as shown in block 120 to produce a Locally Modified Version (LMV) 140, and the remote file is changed as shown in block 130 to produce a Remotely Modified Version (RMV) 150. Conflicts between the Locally Modified Version and the Remotely Modified Version are resolved as illustrated by block 160 to produce a Conflicts Resolved Version (CRV) 170. FIG. 1 illustrates three versions of a file 110, 140, and 150 and a process and apparatus 160 for using those three files to produce a Merged Version.

This invention provides a method of merging files using a visual interface. While the visual interface can be a normal graphical user interface (GUI) common to many windowing systems, the invention is also applicable to a text based interface.

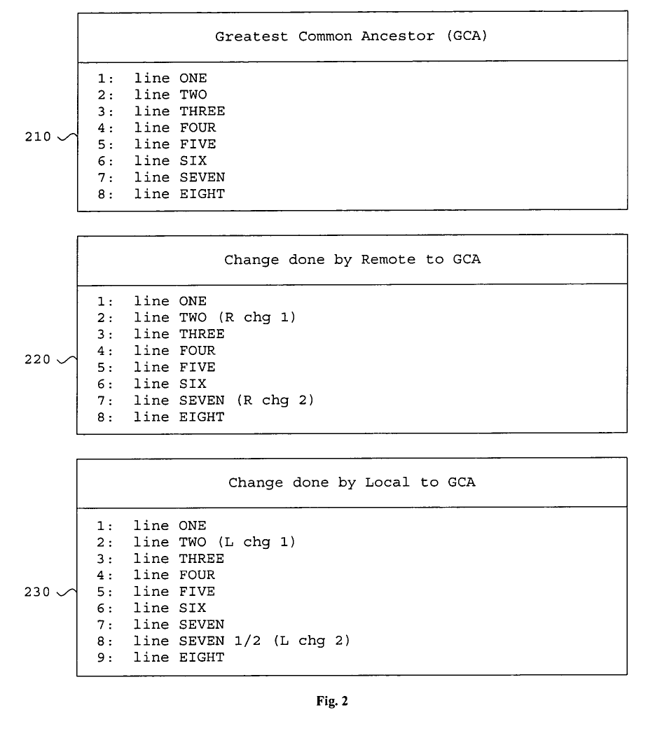

FIG. 2 shows sample files that are used to describe the present invention. FIG. 2 shows an original file 210, the file as modified by work done by a remote user 220, and the file as modified by work done by a local user 230.

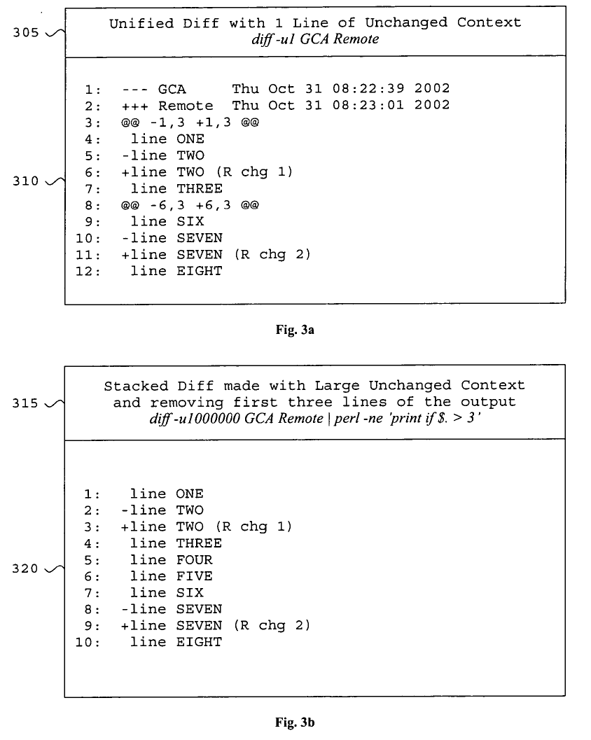

For text files, the combining process is well established and is known as merging. A well-known method of comparing two files is known as “diff”. There are multiple ways diff can show changes. One example is known as the “unified diff format”. FIG. 3a shows the command (block 305) for generating a unified diff with only one common line of context and the results (block 310). The pair of files used to produce the results in FIG. 3a is the GCA in block 210 of FIG. 2 and the Remotely Modified Version in block 220 of FIG. 2. Another example is a variant of the unified diff format. This is the form used by the preferred embodiment of this invention and will be referred to as the “stacked diff format”. FIG. 3b shows the command (block 315) used for generating a unified diff with large common context and the first 3 lines removed and the results (block 320). When the number of common lines is large as to be essentially infinite, then all unchanged lines in the file will be shown. When the first three lines of the unified diff are removed, all that is left are lines in the file. This form is referred to as stacked diffs. FIG. 3b shows sample files that illustrate a stacked diff. Unified diffs typically show a few unchanged lines on each side of a change. The stacked diffs displayed in this invention can be described as uniform diffs with infinite context, wherein infinite context means that all unchanged lines are shown.

The diff in block 310 shows that when comparing files GCA and RMV, line 5 was changed to be “line TWO (R chg 1)”. The change is marked by the presence of a leading “−” showing lines which were deleted by a remote user and by the presence of a leading “+” showing lines which were added by the remote user.

The first two lines in block 310 show which files are being compared. The lines which start “@@” (lines 3 and 8 in block 310) show the region of the files where the change was found. This is useful for displaying a few small differences in a very large file, as only a few matching lines are printed on each side of the change. The information on the “@@” line lets a user know where in the file the changes were found.

In one embodiment of the invention, stacked diffs of GCA vs. Local and GCA vs. Remote are lined up in the visual interface. The invention can simultaneously provide a visual presentation of one or more changes made to a file, displayed as stacked diffs in the body of the file, with the same lines lined up horizontally, when used in the context of merging. At each moment in the process there is a currently active change. There can be many conflicts in the file, but only one is active at a time. The active conflict receives a user's input for resolving the conflict.

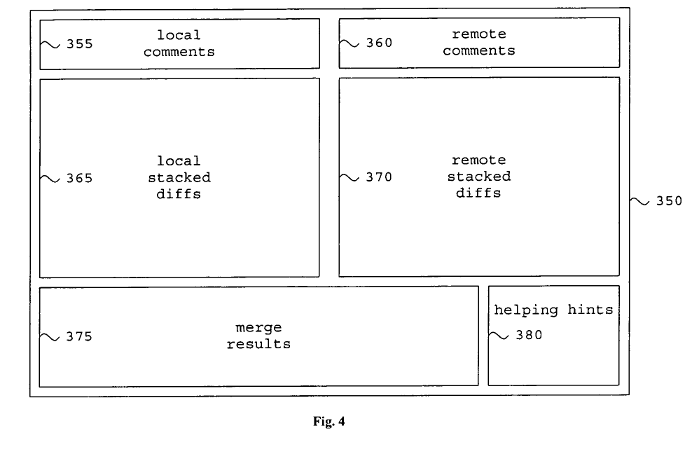

FIG. 4 is a schematic representation of a visual interface used in an embodiment of the invention. FIG. 4 illustrates the layout of the visual interface 350, with windowpanes 355 and 360 for comments, windowpanes 365 and 370 for stacked diffs, windowpane 375 for displaying and manually modifying the results of the merge, and a windowpane 380 for displaying instructions.

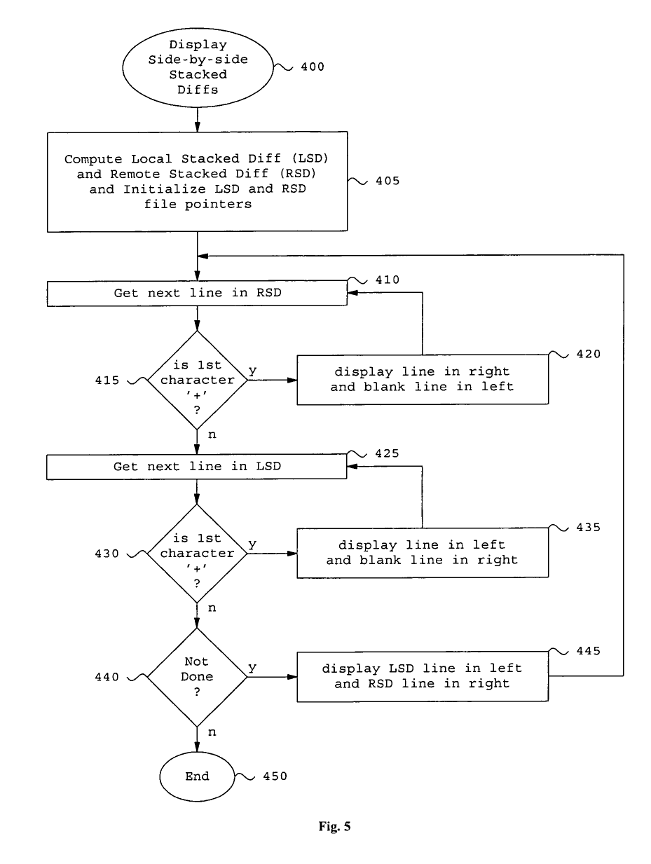

FIG. 5 is a flow diagram of one aspect of the invention. FIG. 5 illustrates the steps taken to display the stacked diffs side by side as shown in block 400. First the local stacked diffs (LSD) and remote stacked diffs (RSD) are computed and file pointers for the LSD and RSD are initialized as shown in block 405. Blocks 410-450 show that the files are read through and portions of the files being compared are displayed in one or both windows depending on various conditions specified 410-450.

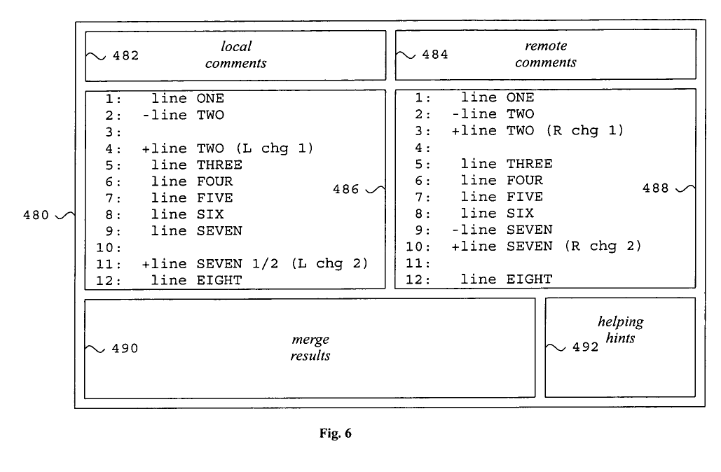

FIG. 6 is a schematic representation of a visual interface 480 used in another embodiment of the invention. FIG. 6 illustrates how the sample files shown in FIG. 2 would be displayed in the stacked diff panes 486 and 488 as a result of the process described in FIG. 5.

When the stacked diffs are displayed between a GCA and two variant files, all the lines which are the same are lined up horizontally. This is shown in FIG. 6 in panes 486 and 488. To generate the display, the stacked diffs between the GCA and Locally Modified Version, and between the GCA and Remotely Modified Version are computed as in block 405 of FIG. 5. Then each of these files is scanned. First, looking in the Remote Stacked Diff (RSD) file is shown in block 410. Block 415 shows that the first character of one line of the file is checked. If the first character is a “+”, then the change was added by the remote user. The change is then displayed in the right window and a blank line is inserted in the left window as shown in block 420. If the first character is not a “+”, the line is held for later use and the next line from the Local Stacked Diff (LSD) is checked as in block 425 and see if its first character is a “+”, signifying a line added by the Local user as illustrated in block 430. If yes, then the line is displayed in the left window and a blank line is displayed in the right window as shown in block 435. If the first character was not a “+”, then the lines are from either LSD or RSD, they must be lines in both, and furthermore, they must be the same text line (though one or both may have a leading “−”). If not, then it is an error condition (assertion and errors are not shown in flow chart). If there is data, then the data lines are displayed in their corresponding window as shown in block 445. If no data is present, then the process is done. By lining up unified diffs of GCA vs. Local, and GCA vs. Remote, this invention increases the speed with which a user can understand the changes.

In version control systems, with a plurality of workspaces, and with one or more users making changes to elements which have a common history, conflicts can result when the changes are combined. To aid in understanding the conflict, this invention computes the stacked diffs of GCA and Locally Modified Version (LMV), computes the stacked diffs of GCA and Remotely Modified Version (RMV), displays two windows side by side with a single scroll, and lines up the display so that common lines line up, and new lines are on lines by themselves, with blank lines filling up space in the adjacent window.

In prior art systems, there were gaps (blank lines on one side) if only one side added many lines. If both sides changed the same region, those changes would be shown across from each other instead of staggered. Typically, neither side includes blank lines.

FIG. 6 shows how the same versions of a file from FIG. 2 would be displayed and lined up in the two stacked diff windows 486 and 488. Pane 482 is provided to display local comments, and pane 484 is provided to display remote comments. The merged results are displayed in pane 490 and instructions are displayed in pane 492. Presenting the information about the GCA, Local and Remote in this way makes it easier for the user to understand what has been done.

The invention can also display checkin comments for the currently active change. While there may be many changes in a file, only one of them is active at a time. Display pane 492 can include instructions for moving from one change to another. For example, by pressing a predetermined key, a user can move to a previous diff or to the next diff. As a user moves from change to change, the set of lines which make up the current change are highlighted. Where lines were added/deleted by one or more revisions to the file, the revisions are recorded events and each event may have what are called “checkin comments”, containing information typically describing the overall change.

To tie the comments to the code, the stacked diffs displayed in panes 365 and 370 are also annotated to keep track of the revision that introduced the annotated line of code. Annotations typically include short, automatically generated character strings based on information like: who, when, and what was the creating version.

As a user moves to a particular change, the apparatus displays, in the top two windows 355 and 360, the checkin comments associated with the highlighted lines in the current diff. Comments are typically something inserted by a user to describe a change, possibly using multiple sentences. This aids in the resolution of conflicting changes as well as provides information for non-conflicting changes.

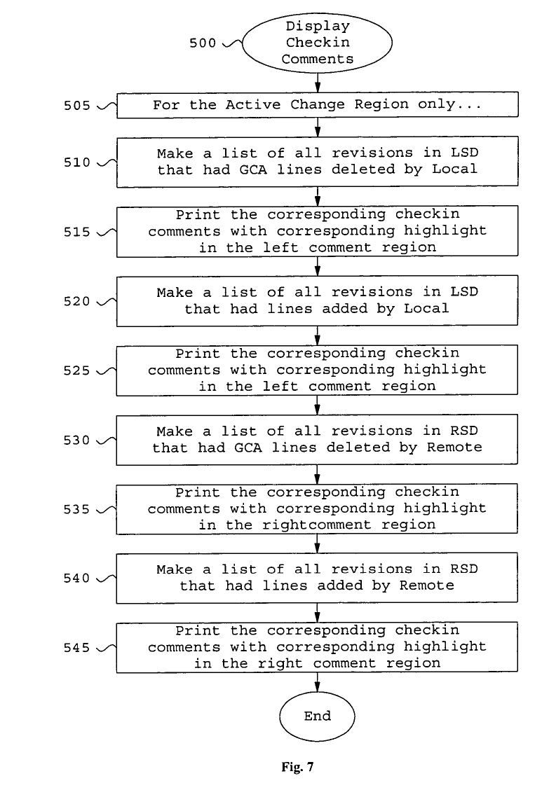

FIG. 7 is a flow diagram of another aspect of the invention. FIG. 7 illustrates the steps used to display checkin comments 500 corresponding to the active change. The process illustrated in FIG. 7 searches over a portion of the stacked diffs, limiting the search to the active change region as shown in block 505. For all lines in the Local Stacked Diff, a list of revisions is created for lines deleted (block 510) and a list of revisions is created for the lines added (block 520). The comments associated with all the deleted revisions are displayed as shown in block 515. Then all of the added revisions are displayed as shown in block 525. This process is repeated for the Remote Stacked Diff as shown in blocks 530-545. By providing for checkin comments for the currently active change, this invention increases the speed with which a user understands the changes.

In one embodiment, the invention includes several steps that aid in understanding the conflict. For the active displayed conflict, the method finds all changes which contributed lines to the conflict, or are responsible for deleting lines in the conflict, gets the checkin comments associated with those changes, and displays them in a way that associates the comment with the lines added or lines deleted section of the conflict (such as with color highlighting).

A simultaneous display of the checkin comments with the change helps the person seeking to understand or resolve conflicts. In addition, displaying revision annotations with the lines in the stacked diff further aids by tying the change comments to specific lines.

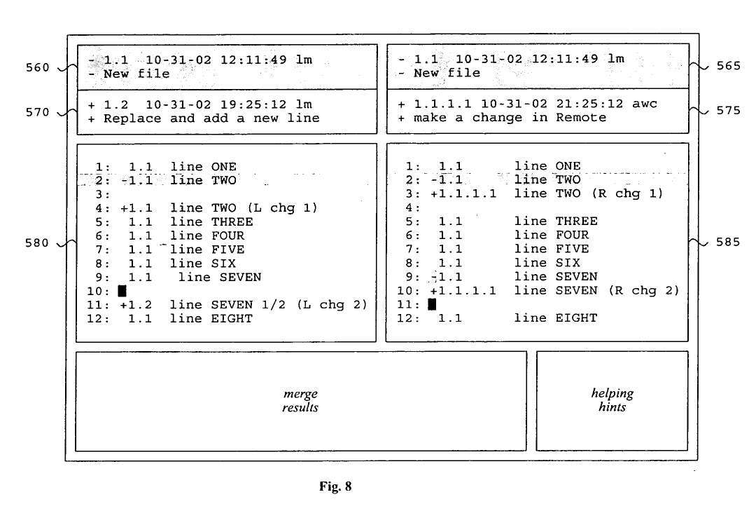

FIG. 8 is a schematic representation of a visual interface used in another embodiment of the invention. FIG. 8 illustrates how the sample files might be displayed by assuming some checkin comments and revision numbers in checkin comments displayed in panes 560, 565, 570 and 575, and line annotations displayed in frames 580 and 585. The display of FIG. 8 shows an active change in panes 580 and 585 though shading, and shows the corresponding change comments for the revisions with lines deleted in panes 560 and 565, and for lines added in panes 570 and 575.

When resolving conflicts, the user typically needs to select all or part of either change. The invention allows the user to select any line or block of lines, in any order, as well as the ability to undo each selection. Repeated undo operations will eventually restore the merge of the current conflict to its original state. Any combination of lines can be selected, in any order, without restriction. Prior art systems frequently restrict the user to choosing either the left change or the right change, but not both.

In response to user actions, the selected line or block changes color and the text is copied to the conflict resolution/merge window. If the selection was a single line that occurred inside a block, then that block can be split into two blocks, each individually available for future selection.

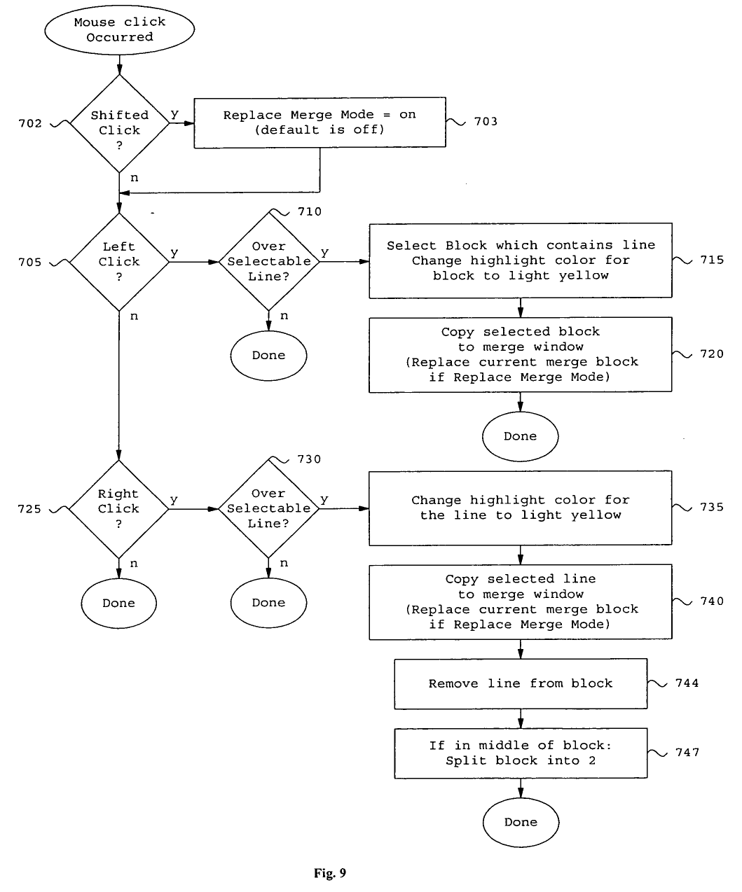

FIG. 9 illustrates the steps taken upon receiving a mouse click in either of the stacked diff windows 365, 370 of FIG. 4 to either select a line or select a block. If it is a left click (705), steps 710-720 are followed, possibly selecting a contiguously highlighted block of text. If it is a right click (725), steps 730-747 are followed, possibly selecting a line of text, and possibly splitting a block of text containing that line. In either case, if the click is done while the shift key is pressed 702, 703, then instead of adding the lines or block to the merge, the merge result will be replaced by the lines or block 720, 740. The preferred embodiment uses a single left click to select a block of lines, and uses a single right click to select a line at a time.

The click to select model allows the user to quickly specify the conflict resolution. For an active conflict region, starting out with no lines for that region in the resulting merge, the method adds a block of text for a distinguishing user action such as a click of the left mouse button, adds a line of text in response to a distinguishing user action such as a click of the right mouse button, builds up the merge window according to the order of the clicks, and allows an undo operation to sequence in reverse through each action taken. A distinguishing action is some action taken by the user that can be identified by a computer as an action separate from other actions. For example, a distinguishing act can be a left or right mouse click, or for a single button mouse, a mouse click done while holding down a particular key.

In the view of the Local/Remote files, it is possible to have annotations on a per line basis. The annotations could be any combination of user name, date, revision number, or any other per revision information associated with the file.

The annotated listing in a merge tool shows what lines go with what comments. It increases understanding of the conflict. The annotation can insert user and/or revision information at the beginning of displayed lines to show either who added or who deleted a line. The invention can optionally display annotations in the side-by-side windows. The annotation can optionally display annotations pertaining to the version that deleted a region. It is also selectable (displayed or not displayed).

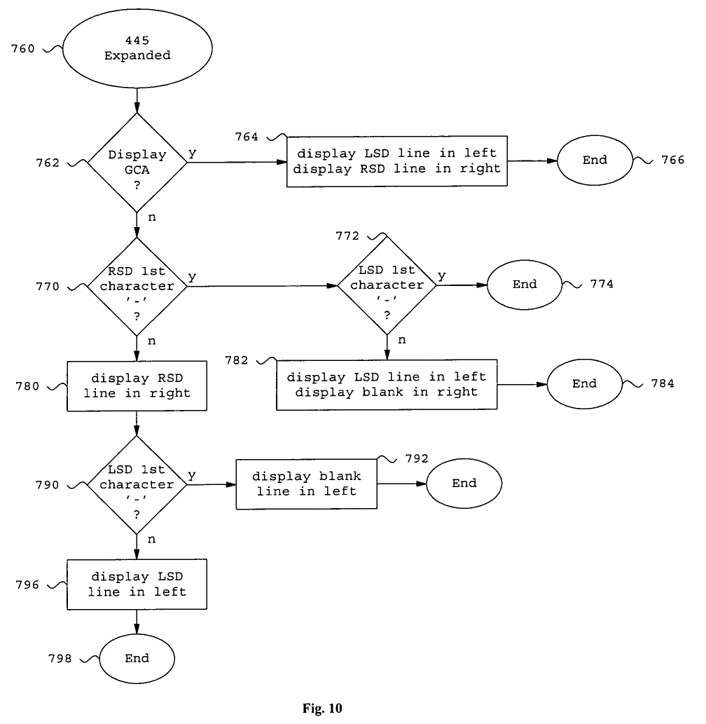

The output described with respect to FIG. 4 is one of many possible output styles. It is also possible to switch to a “no GCA” mode. This is a modification of FIG. 5, block 445. This expansion of FIG. 5, block 445 is shown in FIG. 10. Block 760 is the entry point. Block 762 tests if the user requests to see lines from the GCA that do not appear in the modified version. The default setting is to follow the “y” path to block 764, where both lines are printed, followed by returning (766) to the exit path of FIG. 6, block 445. Otherwise, if both LSD and RSD begin with a “−”, then do not display this line (blocks 770-774). If RSD line begins with “−”, and LSD does not, then display a blank spacer line in the right window and display the LSD line in left window (blocks 770, 772, 782, 784). If RSD line does not begin with “−”, display RSD line in right window (block 780). If LSD begins with a “−”, display a blank spacer line in left window (block 792, 794). Otherwise display LSD line in the left window (block 796, 798).

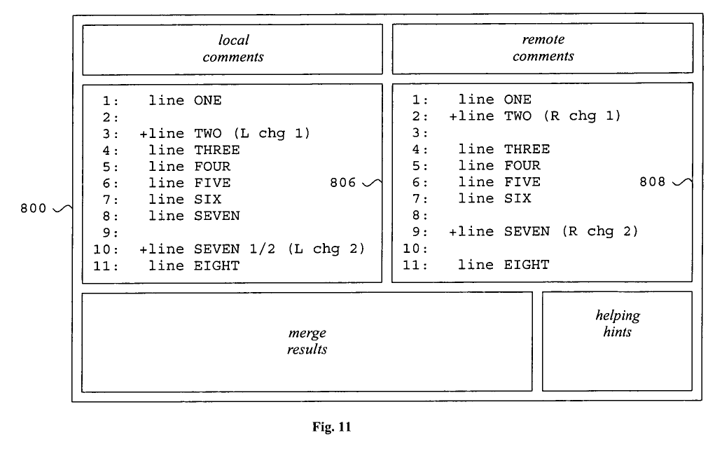

FIG. 11 is a schematic representation of a visual interface used in another embodiment of the invention. FIG. 11 illustrates a display 800 of the sample file without showing the deleted lines in the stacked diff panes 806, 808.

FIG. 11 shows the results of this process for the sample file. FIG. 6 shows the normal results. The line 2 in pane 486 is not shown in pane 806 of FIG. 11. Also line 8 in 808 is a blank spacer line, since this line was deleted by the remote user, but not by the local user.

It is also possible for the user to control whether this style of the display is used for the whole file, or on a diff by diff basis. The invention provides the ability to switch views on the fly. This increases the understanding of the conflict. Sometimes it helps to see the deleted lines, and sometimes it doesn't. In response to a distinguishable user action (menu selection or keyboard shortcut), a toggle feature can be used to show the deleted lines and/or the associated comments.

Metadata is data about the data in the stacked diffs. Metadata has two parts: the data and the relationship of that data to the original data. The data may include version number, date including local time and time zone, user, and checkin comments. The relationship between the metadata and the data may include which version created the data, which version deleted data.

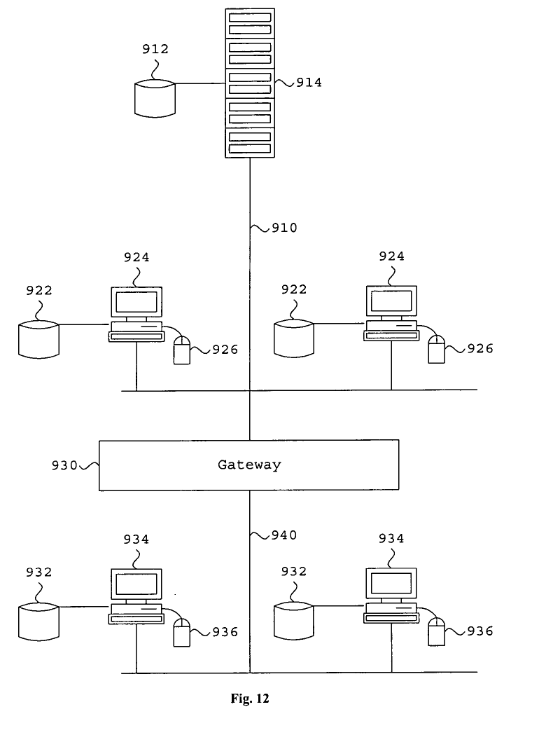

FIG. 12 shows an apparatus for performing the method of the invention. The apparatus includes a local area network (LAN) 910 with a server 914 and disk array 912, as well as a collection of workstations, each including a monitor and keyboard 924, disk storage 922 and a mouse 926. The LAN may be connected through a gateway 930 to other networks, such as the LAN 940 shown with a collection of workstations, each with a monitor and keyboard 934, disk storage 932 and a mouse 936.

In another aspect, the invention encompasses a computer readable medium that includes a computer program that performs the method of the invention.

While the invention has been described in terms of several embodiments, it will be apparent to those skilled in the art that various changes may be made to the disclosed embodiments without departing from the scope of the invention as defined by the following claims.

What is claimed is:

1. A method of merging first and second computer files wherein the first and second computer files are modified versions of a common computer file, the method comprising the steps of:
producing a first set of stacked diffs between the first computer file and the common computer file;
producing a second set of stacked diffs between the second computer file and the common computer file; and
simultaneously displaying the first and second sets of stacked diffs, wherein common lines of the first and second sets of stacked diffs are aligned and new lines of each of the first and second sets of stacked diffs are aligned with blank lines of the other stacked diff.

2. The method of claim 1, wherein the first and second sets of stacked diffs can be scrolled together.

3. The method of claim 1, wherein conflicts between the first and second computer files are displayed and only one conflict is active at a time.

4. The method of claim 3, further comprising the step of displaying version control system metadata relating to the active conflict.

5. The method in claim 4, wherein version control system metadata may insert a revision number, date, checkin comments, and/or user identification pertaining to the version in which data was created.

6. The method of claim 4, wherein version control system metadata may insert a revision number, date, checkin comments, and/or user identification pertaining to the version in which data was deleted.

7. The method of claim 4, wherein the step of displaying version control system metadata relating to the active conflict comprises the steps of:
searching an active conflict of the stacked diffs;
creating a list of revisions for lines deleted from the active portion;
creating a list of revisions for lines added from the active portion; and
displaying the version control metadata relating to the deleted lines and/or the added lines.

8. The method of claim 7, further comprising the step of displaying creation information or deletion information for deleted lines.

9. The method of claim 3, further comprising the step of:
alternatively displaying or not displaying deleted lines in the active conflict in the first and second set of stacked diffs.

10. The method of claim 1, further comprising the steps of:
selecting one line or block of lines from either of the first and second sets of stacked diffs;
copying the selected lines to a conflict resolution pane; and
repeating the selecting and copying steps to achieve a conflict resolution.

11. The method of claim 10, further comprising the step of:
undoing the selection and copying steps.

12. The method of claim 10, further comprising the step of:
moving to a successive or previous conflict.

13. The method of claim 1, further comprising the step of:
alternatively displaying or not displaying deleted lines in the first and second sets of stacked diffs.

14. The method of claim 1, further comprising the steps of:
alternatively displaying or not displaying annotations with the first and second sets of stacked diffs.

15. An apparatus for merging first and second computer files wherein the first and second computer files are modified versions of a common computer file, the apparatus comprising:
means for producing a first set of stacked diffs between the first computer file and the common computer file and for producing a second set of stacked diffs between the second computer file and the common computer file; and
means for simultaneously displaying the first and second sets of stacked diffs, wherein common lines of the first and second sets of stacked diffs are aligned and new lines of each of the first and second sets of stacked diffs are aligned with blank lines of the other stacked diff.

16. The apparatus of claim 15, wherein the means for simultaneously displaying the first and second sets of stacked diffs displays version control metadata relating to the active change.

17. The apparatus of claim 15, further comprising:
means for selecting one or more lines from each of the first and second sets of stacked diffs and for copying the selected lines to a conflict resolution pane.

18. The apparatus of claim 15, further comprising:
means for displaying annotations in the first and second sets of stacked diffs.

19. The apparatus of claim 15, further comprising:
means for alternatively displaying or not displaying deleted lines in the first and second sets of stacked diffs.

20. A computer readable medium including a computer program for merging first and second computer files wherein the first and second computer files are modified versions of a common computer file, the computer readable medium comprising:
computer readable means for producing a first set of stacked diffs between the first computer file and the common computer file and for producing a second set of stacked diffs between the second computer file and the common computer file; and
computer readable means for simultaneously displaying the first and second sets of stacked diffs, wherein common lines of the first and second sets of stacked diffs are aligned and new lines of each of the first and second sets of stacked diffs are aligned with blank lines of the other stacked diff.

21. The computer readable medium of claim 20, further comprising:
computer readable means for selecting one or more lines or one or more blocks of lines from each of the first and second sets of stacked diffs and for copying the selected lines to a conflict resolution pane.
